(19) United States
(12) Patent Application Publication
(10) Pub. No.: US 2024/0406504 A1
(43) Pub. Date: Dec. 5, 2024

(54) Human-Computer Interaction Based System with Multi-Modal Learning for Real-Time Dynamic Content Curation

(71) Applicant: Christy King, Clark, NJ (US)

(72) Inventor: Christy King, Clark, NJ (US)

(73) Assignee: CreAIture LLC, CLARK, NJ (US)

(21) Appl. No.: 18/668,192

(22) Filed: May 19, 2024

(51) Int. Cl. H04N 21/462; H04L 65/1063; H04L 65/1096

(52) U.S. Cl. CPC H04N 21/4622; H04L 65/1063; H04L 65/1096

(57) ABSTRACT

The present invention introduces a novel system and method for real-time content creation, curation, and augmentation, leveraging integrated generative artificial intelligence (AI) and multimedia processing. Through a blend of machine learning, computer vision, and natural language processing, the system synthesizes diverse creative content, encompassing visual and textual outputs, in response to live human input such as audio and visual feeds. The system's architecture, depicted through various diagrams, elucidates the flow of data and interaction modalities inclusive of user preferences. The presented invention is achieved through integrating advancements in multimedia processing, human-computer interactions, natural language processing, content generation, and real-time data processing.

### FIELD OF THE INVENTION

The present invention relates to the fields of artificial intelligence (AI), Human-Computer-Interactions, Multimedia Processing and Real-Time Data Analytics. More specifically, the present invention relates to real time processing of audio and visual inputs through generative AI solutions to provide curated creative content, iteratively and dynamically.

### BACKGROUND

There is an unmet need for AI based solutions that can augment human capability with generative content continuously in real-time. Current advancements in systems that employ generative AI are unable to achieve this because they are limited by a combination of 2 factors. 1) the use of live continuous human input such as audio and visual 2) the creation of real time dynamic generative output that continues to improve as the feed of human input changes.

### SUMMARY OF THE INVENTION

The primary objective of the current invention is to create an integrated generative AI and real-time multimedia processing system and method employing multi-modal learning (i.e. machine learning, computer vision and natural language processing) for synthesizing and generating diverse creative content encompassing visual and textual outputs.

### Comparative Advantage

The proposed system distinguishes itself from prior art by integrating 5 distinct fields/technologies to create an ecosystem of content delivery that augments human capability in real-time. These technologies include multimedia processing, human-computer-interactions, natural language processing, content generation, and real-time data processing and analytics. The present invention is designed to transform the way humans interact with machines and digital content; this state-of-the-art invention marks a paradigm shift in the technological landscape.

### BRIEF DESCRIPTION OF DRAWINGS

The drawings depict some embodiments of the invention and are provided for illustrative purposes. The scope of the invention is not limited to the specific features shown, and various modifications or alternative embodiments may be contemplated without departing from the spirit and scope of the invention. Together with the description, these figures serve to explain the principles of the methods and system:

Specific elements and features are identified by reference numerals and described in detail to facilitate a comprehensive understanding of the invention.

FIG. 1 is a block diagram of the schematic representation of the system's core components inclusive of the high-level flow of information through the system during a real-time content curation session. It includes components such as the User Client (2), the Application Interface (2.1), and Content Generation (6). Arrows indicate the flow of data between components.

FIG. 2 is an Architecture Diagram illustrating the core technical components of the system.

FIG. 3 is a Block Diagram illustrating the flow of data through the system.

FIG. 4 is a User Interface Diagram that expands on FIG. 1 element 2.2.1 illustrating various potential levels of user interaction with the system as well as functionality offered to the user during a real-time content curation session.

FIG. 5 is a User Interface Diagram that expands on FIG. 1 element 2.2.1, illustrating the various ways the user can interact with content that has been generated once the live session has ended.

FIG. 6 is a User Interface Diagram that expands on FIG. 1 element 2.2.1, it illustrates the user-input options for directing the system's actions and outputs during the real-time content curation session.

FIG. 7 is a User Interface Diagram illustrating functionality for authentication and authorization within the system.

FIG. 8 is a Block Diagram illustrating the various technology components of a user device that will be leveraged by the system.

FIG. 9 is a User Interface Diagram that expands on FIG. 1 element 2.2.1, illustrating the augmentation described in embodiment 2 of the proposed invention.

FIG. 10 is a block diagram illustrating the technology components unique to embodiment 2 of the proposed invention.

### DETAILED DESCRIPTION

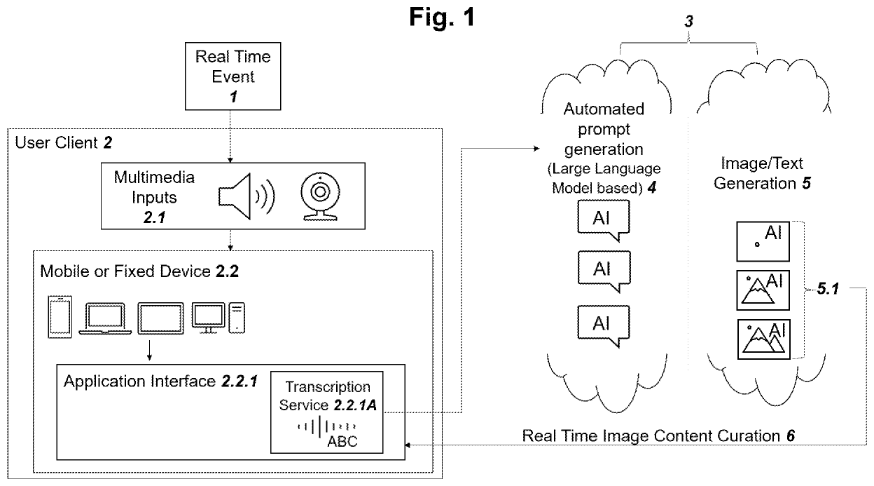

Referring now to FIG. 1, there is shown the system adapted to support one embodiment of the present invention. The system leverages the user client 2 to intake multimedia inputs 2.1 based on a real time event 1 being experienced by the user. The User Client 2 refers to a system or a program that requests the activity of one or more other systems or programs. The user client 2 can take the form of any number of personal hardware devices 2.2, for example mobile or laptop device. A real time event may include various activities outside of the system, for example: presentation, lecture, narration, conference event, business meeting, video chat, audio call etc. In addition, multimedia input 2.1 can take the form of any live stream of information, for example, audio or video feed.

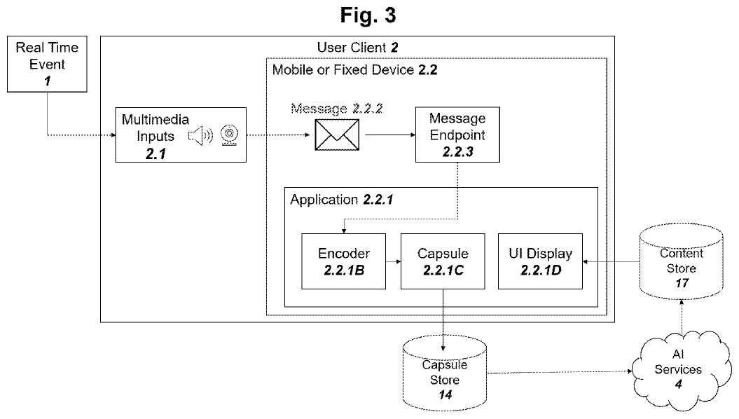

To initiate a creative session and leverage the proposed invention, the user will interact with the systems application interface 2.2.1. Via the application interface fragments of the live stream of multimedia content 2.1, as well as curated text transcriptions of the content 2.2.1A, are passed through to the system AI processing module 3 for further processing. In order to enable real time content curation, this embodiment of the invention periodically sends the pre-processed input feed to the AI system in the form of capsules 2.2.1C (Refer to FIG. 3). By definition, a capsule 2.2.1C is a structured compilation of user input. In this embodiment of the invention the capsule takes the form of a json string/file.

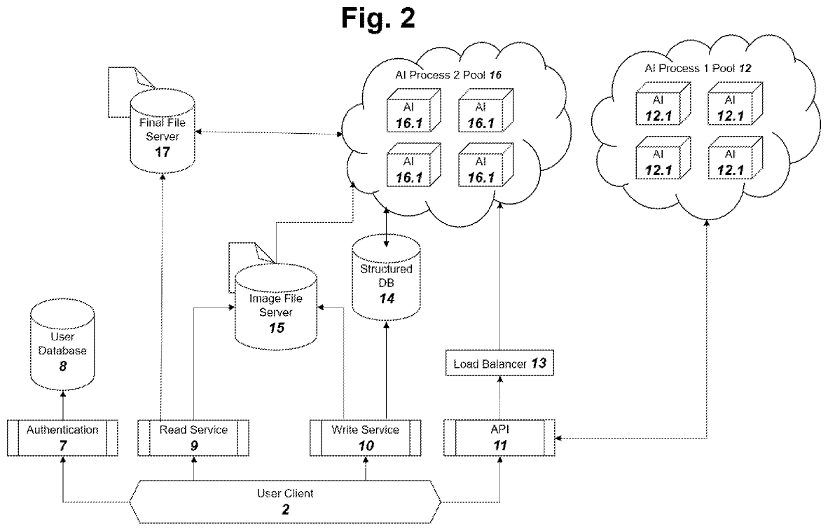

When the capsule is passed via various technical components (Refer to FIG. 2) to the AI processing module, the transcriptions are processed through a first generative large language model 4. The before-mentioned processing manifests appropriate text-based prompts that are then provided to the 2nd generative AI model 5 for content creation. A generative AI model is a type of artificial intelligence system that can generate new content, such as images, text, or other multimedia, based on input and prompts. The first AI process analyzes the transcription to determine what information in the transcription is most relevant and how a strong prompt can be phrased/created from the capsule content to successfully generate creative content during the 2nd AI processing.

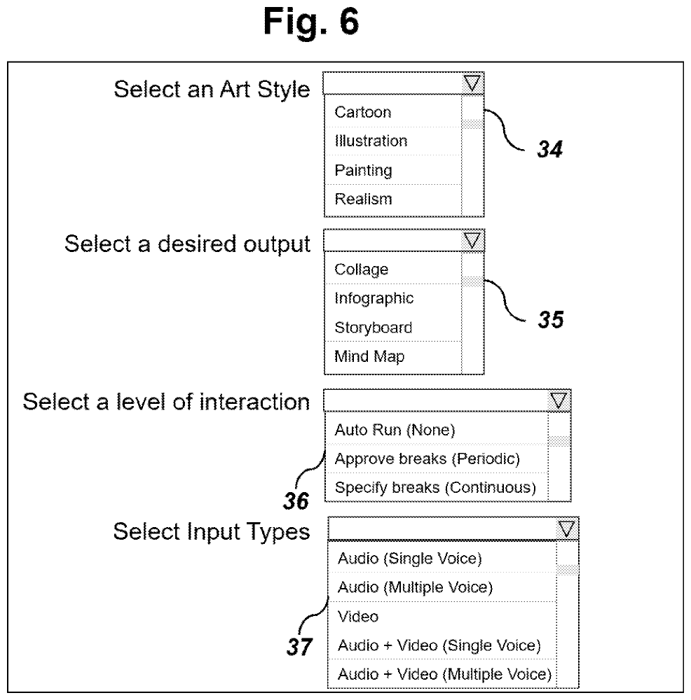

A prompt is a natural language question or statement often containing instructions and contextual information; it is provided to a generative AI to help it understand what content to create. For this embodiment of the invention the generative AI leverage for the creative content curation is an image generator. Based on the user preferences selected in the application interface (Refer to FIG. 6), the content generation process 5 occurs iteratively to improve upon created content 5.1. Once deemed complete, a curated content piece is provided back to the user via their device 2.2 and the application interface 2.2.1 in real time 6. The curated content may be displayed in various forms for example: an overlay of content on top of the live video stream or recording, a static image, dynamic/changing image, a sequence of the current and recent images.

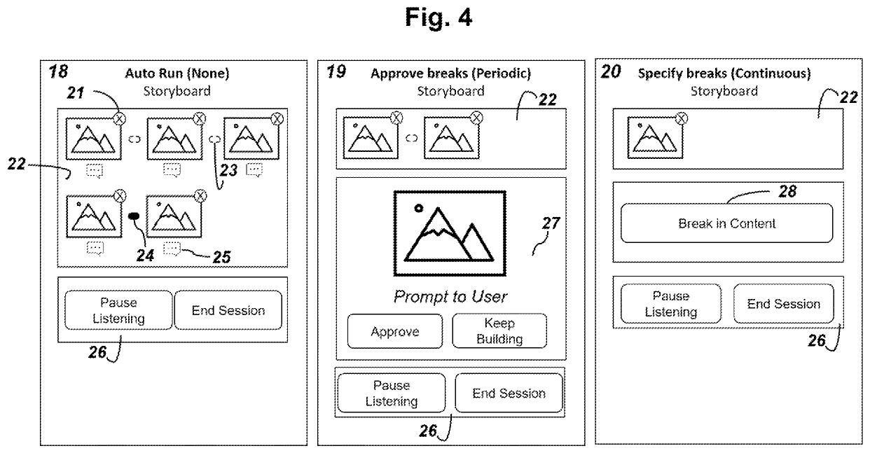

Within FIG. 4, there are illustrated various aspects of the users experience within the system during the content curation process. There are 3 proposed levels of interactivity, for this embodiment of the invention. The first, is an “Auto Run (None)” zero interaction option 18. This option requires no interaction from the user during the session other than to pause the input feed or to end session 26. Within this interaction level the system will automatically create content at natural breaks within the input feed, the 1st AI processing will determine when a natural pause or change in ideas has occurred within the input content and create appropriate output content following each pause 22. The second, is an “Approve Breaks (Periodic)” interactions option 19 in which each time the system thinks there has been a natural pause or change in ideas it will request the user to approve that the assumption is correct, and a piece of content should be created at that point. Alternatively, the user can force the system to keep building a prompt for the next piece of content 27. The Third, is a “Specify breaks (Continuous)” interaction option 20 in which the user provides continuous feedback to the system, manually specifying when there is a pause in the input or a change in ideas and the system should create a new piece of content 28. Within the latter two levels of interaction (19 and 20) the user can still pause or end the session 26.

The proposed embodiment also includes various ways for the user to interact with the content being created while the session is live. Element 21 demonstrates the ability to delete any piece of content that has been created. Elements 23 and 24 show the ability to toggle and request that the system combines content that it has created into a single piece of content post session. If content is to be combined, it will be reprocessed by the AI to curate a new piece of content that conceptually includes both the first and 2nd pieces of content. For example, 2 images would be re-created into a single image conveying both thoughts. 25 demonstrates the ability to add captioning to any piece of content that has been created by the system.

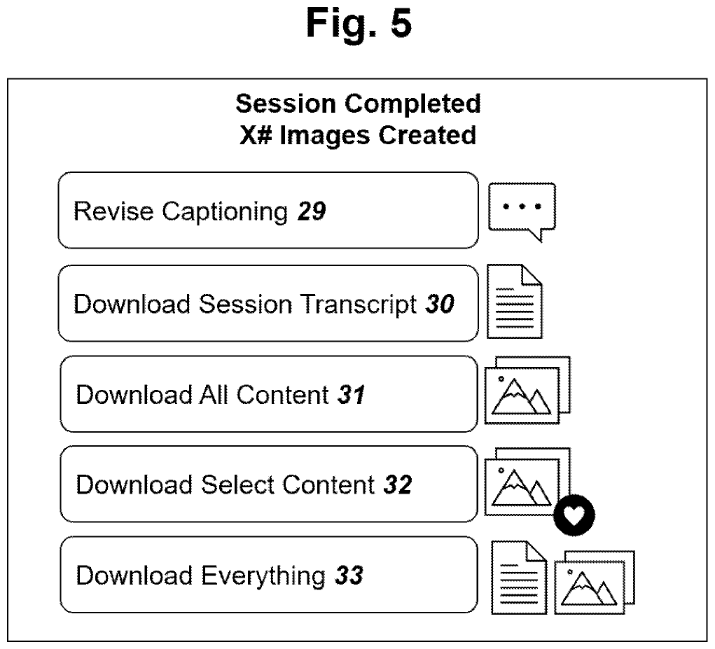

Regarding FIG. 5, when the user selects to end the session, they will be brought to a set of post session options that allow various interactions with the content that was provided live during the session. Within this embodiment of the proposed invention these options include: Revise Captioning 29 (allows the user to edit captioning that is attached to sessions content pieces), Download Session Transcript 30 (allows the user to download the full text transcript of the session), Download All Content 31 (allows the user to download all content created during the session), Download Select Content 32 (allows the use to review the list of all content pieces generated and select only the content pieces they are interested in downloading), Download Everything 33 (allows the user to download all content and the transcript simultaneously). Downloads are made available in various standard formats for example.jpg.

As illustrated in FIG. 6, upon initiating a session within the proposed invention, the user will have the opportunity to sel their intent. This is done by providing the parameters of the content to be created. In this embodiment user can provide: a particular art style of interest 34 (e.g. Cartoon), the desired format of the final output 35 (e.g. storyboard), the level of interaction they wish to have with the content generation during the session 36 (e.g. Auto Run) and the type of input they will be providing 37 (e.g. Audio-Single Voice)

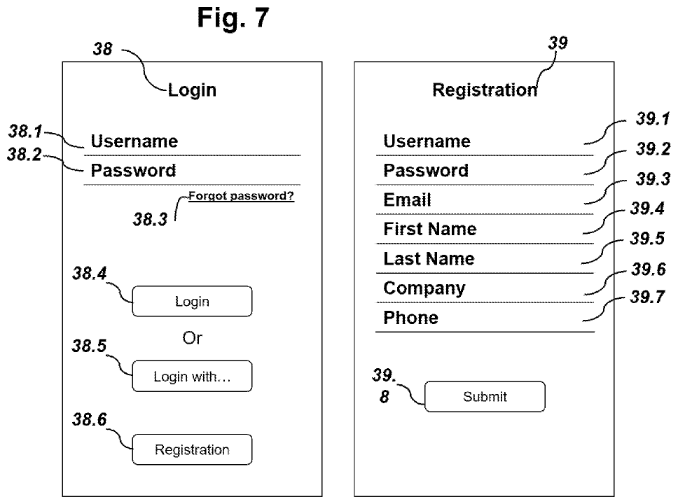

This embodiment of the proposed invention also includes registration 39 and login 38 functionality as illustrated in FIG. 7. Users complete both before interacting with the content creator. The registration includes: a user name 39.1, password 39.2, email address 39.3, first name 39.4, last name 39.5, company 39.6 and phone number 39.7. This information would allow the system to maintain a record of the user's membership information. Registration may also include membership fees and payment information dependent on the embodiment of the invention. Upon login the user will provide their username 38.1 and password 38.2 and click a Login button 38.4. Alternatively, the user can choose to login by leveraging a connected account 38.5. If the user has forgotten their password, they can click the link to complete a password recovery 38.3. From the login screen 38 there will also be a link to the registration options 38.6 for any new user.

Referring now to FIG. 2, the technical components of the proposed embodiment are illustrated. The user client 2 is connected to a User Database 8 that is leveraged for authentication 7 to ensure secure access to the system via a login process. All capsules 2.2.1C created by the user client are stored in a Capsule structured database 14, which is accessed via a write service 10. A structured database is a database system where data is organized and stored in a predefined manner, often using a schema that defines the structure of the data, including tables, fields, and relationships. Any Image content, provided by the User Client, is stored in an Image File Server 15 and the resulting content generated by the AI processing 16.1 is also stored on a File Servicer 17. A file server is a computer attached to a network that provides a location for shared disk access, i.e., storage of computer files that can be accessed by workstations within a computer network. The User Client communicates via API 11 to the AI Pool 12 for AI Process 1 12.1 (as described in FIG. 1 element 4). The API 11 receives the processed prompt from the 1^{st} AI Pool 12 and passes the updated capsule 2.2.1C which includes the generated prompt forward to the 2^{nd} AI Pool 16. Within the 2^{nd} AI Pool 16, the capsule is processed through the content generating AI 16.1 (as described in FIG. 1 element 5). The requests are distributed by a Load Balancer 13 to maintain efficiencies. A load balancer is a component that evenly distributes incoming network traffic among multiple servers to optimize resource utilization and ensure no single server is overwhelmed. There also exists a Read Service 9 which allows the User Client 2 to access both the image file server 15 and final file server 17.

To provide further clarification FIG. 3 illustrates the flow of data through the described system. Data is initially generated by a Real Time Event 1 in the form of multimedia inputs 2.1 to the User Client 2. These inputs are passed as a message 2.2.2 to the Message Endpoint 2.2.3. The Message Endpoint 2.2.3 determines where in the application layer information should be processed, informing the system what format of content was created during the real time event 1 and which preprocessing needs to occur before the information can continue through the system. Once analyzed, the content is passed to an encoder 2.2.1B. The encoder extracts the information within the message and processes it into a Capsule 2.2.1C (described above). The Capsule contains various information, including but not limited to: IDs, Name, Description, Links to Images, Meta Data. Once generated Capsules are written to the Capsule Store Structured Database 14, where they exist for future reference. Data/Capsules then flow through the AI Services and curated data/content is stored in the Content Store/Final File Server 17. Data is displayed during and after real-time sessions, for example, in the form of images on the User Client's UI 2.2.1D.

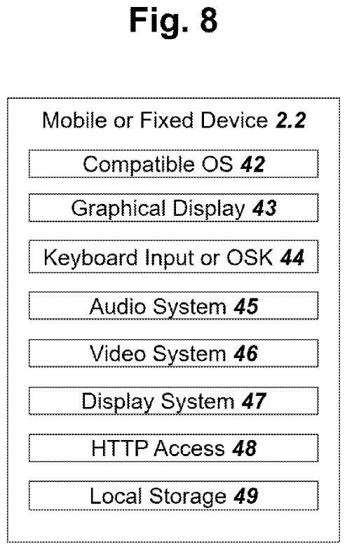

There are various required technologies that must be present on the user device 2.2 for the system to successfully run, these are illustrated in FIG. 8. Firstly, the devices will require a compatible operating system 42. In this embodiment a compatible operating system may be any of the following: Android, IOS, Linux or Windows. These operating systems include various inbuilt services for interacting with the various components of the devices (e.g. the graphical display). The proposed embodiment of the invention requires access to the Graphical Display 43 which provides the device a place to show the user content. Similarly, the invention will require access to the Display System 47 which enables the ability to push visuals to the devices display. It requires access to a physical Keyboard Input or an on screen keyboard 44 for user interactions (for example caption creation as described in FIG. 4 element 25). Access to the Audio System 45 is required to record content from the live session. Access to the Video System 46 is an optional alternative for recording content beyond just Audio. User devices will also require HTTP (Hypertext Transfer Protocol) Access 48. HTTP is the foundation of data communication on the World Wide Web, and will be used for transmitting data within the proposed invention. Lastly, the invention requires access to Local Storage 49 A hard drive or solid state drive (SSD) directly attached to the device, in order to complete various activities/tasks discussed earlier in this section.

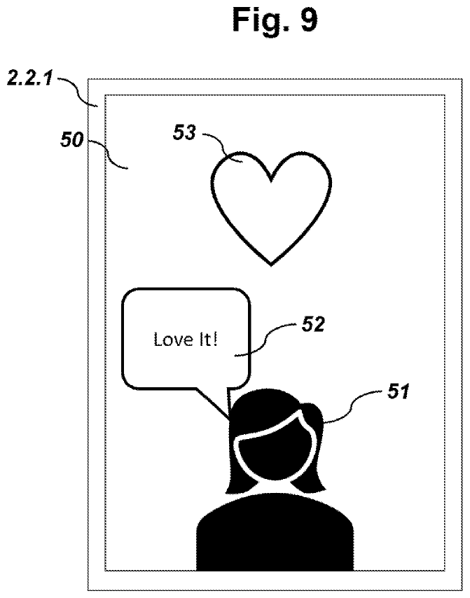

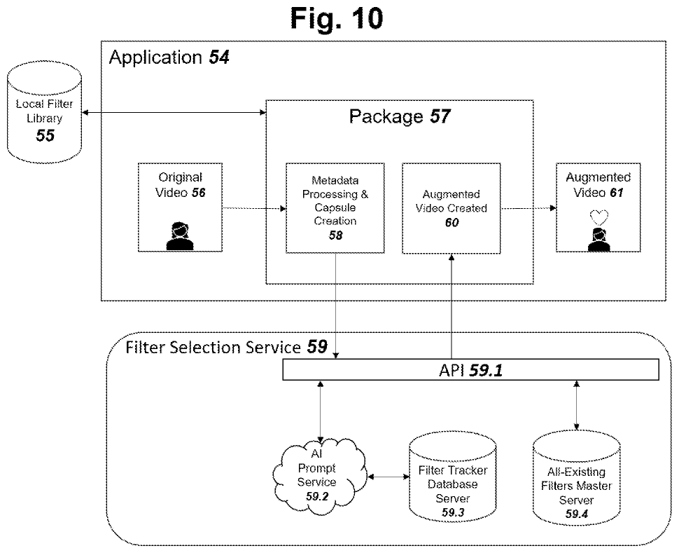

FIG. 9 provides an example of a 2^{nd} embodiment of the proposed invention, in which, the real-time AI processing is used to provide augmentative content 53, such as what are traditionally referred to as “filters” or “visual effects”, to overlay on an outgoing video stream 50 as it is occurring on the user's device 2.2. This can be implemented in several ways, including for example, as a package 57 enabled API 59.1 service as shown in FIG. 10. In this instance the audio feed 52 will inform the underlying technologies and AI of the context of the conversation this may include for example language, body language etc. The AI will automatically generate and or apply a relevant filter 53 for the user 51. Similar capabilities could be employed for video calls and video recording.

For an embodiment that leverages a Filter Selection Service 59 as show in FIG. 10, an Application 54 may initiate a video recording, and as the original video is recorded 56 it is passed through the packaged service 57 for augmentation. The augmented video 61 is then displayed back to the user via the application 54 to create the seamless real-time curated/augmented content experience.

In this embodiment, the application 54 employs locally stored filters 55 that can be applied to an original video 55 based on recommendations from a generative AI informed Filter Selection Service 59. As the original video 55 is recorded by the application 54 it is processed by a package 57 within the application to create metadata 58. The metadata 58 is passed from the application 54 to the Filter Selection Service 59 for further processing. The information is passed to the Filter Selection service 59 via API 59.1. The Al Prompt Service 59.2 then performs several actions. The transcription of the video is processed by AI to assess key terms relevant to the current content feed. Key terms identified are compared to records in the Filter Tracker Database Server 59.3. The File Tracker Database Server 59.3 contains metadata for all available filters. A ranking procedure is leveraged to systematically determine the most relevant filter to apply to the current content feed. Once a proposed filter has been selected, the API 59.1 checks for the availability of the specified filter in the Local Filter Library 55. If the filter has not been downloaded, the Filter Selection Service 59 may suggest a next best option. Alternatively, the Filter Selection Service 59 will initiate a download process to add the originally suggested filter from the All-Existing Filters Master Server 59.4 to the Local Filter Library via the API 59.1 and Package 57. The All-Existing Filters Master Server 59.4 contains all filter files that could be employed by the application if downloaded for use. Once the suggested filter is available in the Local Filter Library 55 it can be applied by the Package 60 to create the Augmented Video 61 which is then displayed via the interface to the user in real time.

1. A method of real-time continuous content curation, comprising:
a user client (2) configured to intake multimedia inputs (2.1) based on a real-time event (1);
an application interface (2.2.1) configured to receive and process live stream multimedia content (2.1);
an AI processing module (3) which further processes the data via a combination of generative artificial intelligence models (4, 5), wherein the curated multi-model content (5.1) is created and provided back to the user in real-time (6).

2. A method of real-time continuous content curation comprising:
a user device (2.2) which records input streams (50) using an application (54);
a Local Filter Library (55) from which augmentative content (53) can be applied;
a Filter Selection Service (59) integrated with the said application (54) to analyze video content with an AI prompt service (59.2), wherein the most applicable augmentative content (53) for the current point in said input stream (50) will be automatically identified and applied (60).

3. A method of real-time continuous content curation, as in claim 1, wherein the said application interface (2.2.1) accepts preferences (34-37) and ongoing feedback (18-20) from the user to create an interactive content curation (5.1) session.

4. A method of real-time continuous content curation, as in claim 1, wherein the curated content (5.1) generated by said generative AI model (5) is an image or series of images based on the user preferences (34-37) selected in the application interface (2.2.1).

5. A method of real-time continuous content curation, as in claim 1, wherein said application interface (2.2.1) is configured to transmit fragments of the live stream multimedia content (2.1) and curated text transcriptions (2.2.1A) to said Al processing module (3) for further processing.

6. A method of real-time continuous content curation, as in claim 1, wherein said live stream multimedia content (2.1) is pre-processed into structured capsules (2.2.1C) before being transmitted to said AI processing module (3).

7. A method of real-time continuous content curation, as in claim 1, wherein said first generative large language model (4) analyzes transcriptions to generate text-based prompts, which are then used by said second generative AI model (5) to create said curated content (5.1).

8. A method of real-time continuous content curation, as in claim 1, wherein said Al processing module (3) automatically creates content at natural pauses within the said multimedia inputs (2.1).

9. A method of real-time continuous content curation, as in claim 1, wherein said Al processing module (3) will re-process curated content through the Al, to combine multiple pieces of content into, a single newly curated piece of content post session (23, 24).

10. A method of real-time continuous content curation, as in claim 1, further comprising post-session options (29-33) for interacting with said curated content (5.1).

11. A method of real-time continuous content curation, as in claim 2, wherein said application (54) initiates the input recording (56) and generates metadata (58) from the recorded input stream (50), the metadata (58) being used to identify relevant augmentative content (53) by the Filter Selection Service (59).

12. A method of real-time continuous content curation, as in claim 2, wherein said Al Prompt Service (59.2) transcribes the input stream (50) and identifies key terms relevant to the content, comparing them to metadata in the Filter Tracker Database Server (59.3) to select the most relevant augmentative content (53).

13. A method of real-time continuous content curation, as in claim 2, wherein said Filter Tracker Database Server (59.3) ranks available augmentative content based on relevance to the key terms identified, systematically determining the optimal said augmentative content (53) to apply to the original input (56) and create the augmented content (61).

14. A method of real-time continuous content curation, as in claim 2, wherein said Filter Selection Service (59) checks the availability of the select augmentative content (53) in the Local Filter Library (55), and if unavailable, initiates a download from the All-Existing Filters Master Server (59.4).

15. A method of real-time continuous content curation, as in claim 2, wherein said augmentative content (53) applied to the input stream (50) includes filters, visual effects or other graphical enhancements.

16. A method of real-time continuous content curation, as in claim 2, wherein the augmented output (62) is displayed back to the user through said application interface (54) in real time, allowing the user to see applied augmentative content (53).
